(19) United States
(12) Patent Application Publication
(10) Pub. No.: US 2004/0080546 A1
(43) Pub. Date: Apr. 29, 2004

(54) Print menu macros for printing devices

(76) Inventor: Terry M. Fritz, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/280,804

(22) Filed: Oct. 25, 2002

(51) Int. Cl. G06K 15/02; G06F 13/00; G09G 5/00

(52) U.S. Cl. 345/826; 358/1.15; 345/704

(57) ABSTRACT

Print menu macros for printing devices can be created and print parameters can be set in accordance with the macros. In accordance with one aspect, a printing device includes an input component through which a user can input a print menu macro for the printing device. In accordance with another aspect, printing device includes an input component through which a user can select a print menu macro for the printing device and have print parameters for the printing device set in accordance with the selected print menu macro.

### TECHNICAL FIELD

This invention relates generally to printing devices, and more particularly to print menu macros for printing devices.

### BACKGROUND

As computer technology has advanced, so too has the technology of peripheral devices used by computers, such as printers which allow users to generate hard copies (e.g., paper copies) of electronic documents supplied to the printer by a computer. These advances have resulted in printers becoming increasingly commonplace in homes, businesses, and elsewhere throughout the world.

Many printers that are currently available have print menus that allow users to set various print parameters such as duplex/simplex printing, number of copies, print quality, etc. These print parameters are then used by the printer when printing documents. These printers also typically have interfaces, such as keypads and displays, that allow a user to interact with the printer's print menu. For example, the menu can be displayed on the printer's display and the user can maneuver through the various menu items and set them as he or she desires using the printer's keypad.

One problem encountered with these print menus, however, is that often times users request particular print parameter settings repeatedly. Using current printers, the user typically must enter these particular print parameter settings each time he or she uses the printer.

### SUMMARY

Print menu macros for printing devices are described herein.

In accordance with one aspect, a printing device includes an input component through which a user can input a print menu macro for the printing device.

In accordance with another aspect, a printing device includes an input component through which a user can select a print menu macro for the printing device and have print parameters for the printing device set in accordance with the selected print menu macro.

### BRIEF DESCRIPTION OF THE DRAWINGS

FIG. 1 illustrates an exemplary environment in which the print menu macros for printing devices can be employed.

FIG. 2 is a block diagram illustrating an exemplary printing device in additional detail.

FIG. 3 is a flowchart illustrating an exemplary process for creating a print menu macro.

FIG. 4 is a flowchart illustrating an exemplary process for playing back a print menu macro.

FIG. 5 illustrates portions of an exemplary device.

### DETAILED DESCRIPTION

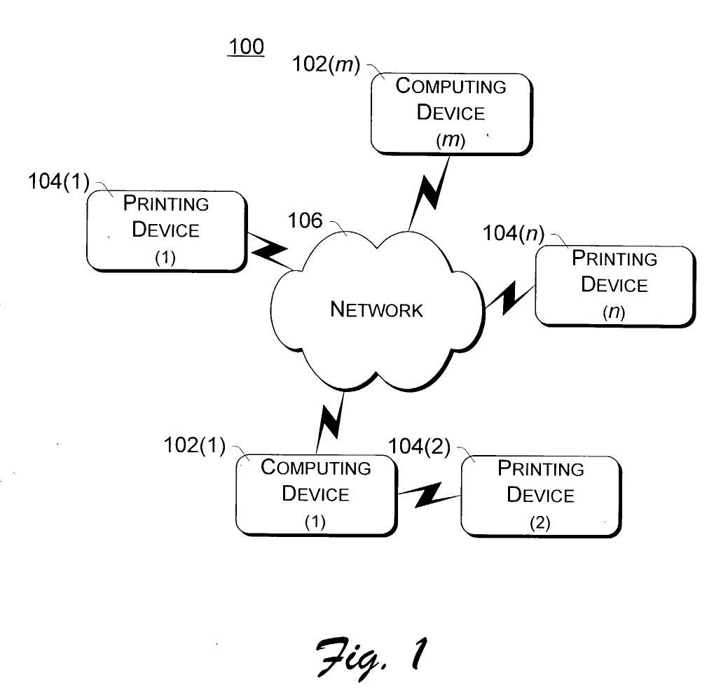

FIG. 1 illustrates an exemplary environment 100 in which the print menu macros for printing devices can be employed. In environment 100, multiple (m) computing devices 102 are coupled to one or more of multiple (n) printing devices 104 via a network 106 and/or directly. Network 106 is intended to represent any of a wide variety of network topologies and types (including wired and/or wireless networks), employing any of a wide variety of network protocols (including public and/or proprietary protocols).

Computing devices 102 can be any of a wide variety of computing devices, including desktop PCs, workstations, server computers, Internet appliances, gaming consoles, handheld PCs, cellular telephones, personal digital assistants (PDAs), etc. Computing devices 102 can be the same types of devices, or alternatively different types of devices.

Printing devices 104 can be any of a wide variety of devices capable of generating a hard copy of data (e.g., received from one of computing devices 102). Examples of printing devices include printers, facsimile machines, multi-function machines (e.g., capable of performing multiple functions, such as the functions of both a printer and a facsimile machine). Printing devices 104 can generate hard copies of data in any of a variety of manners, such as by using toner (e.g., in laser printers), ink (e.g., in inkjet printers, bubblejet printers, dot matrix printers, etc.), heat applied to heat-sensitive print media (e.g., thermal printers), and so forth. Printing devices 104 can be the same types of devices, or alternatively different types of devices.

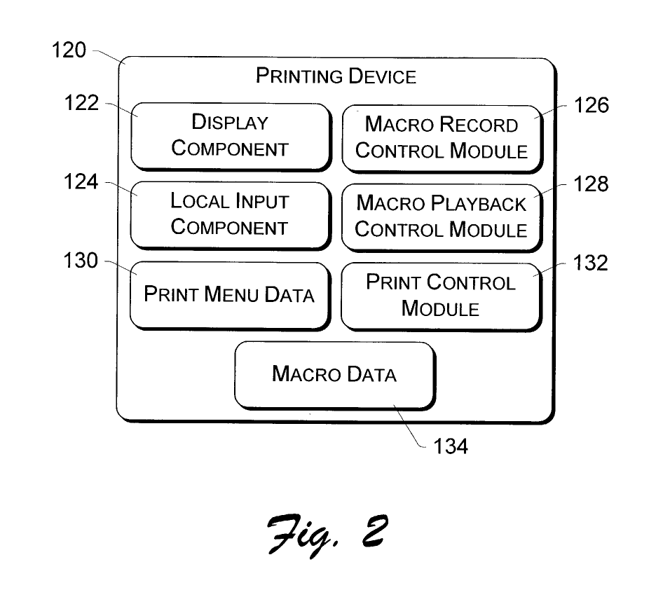

FIG. 2 is a block diagram illustrating an exemplary printing device 120 in additional detail. Printing device 120 can be any of printing devices 104 of FIG. 1. Printing device 120 includes several modules or components: display component 122, local input component 124, macro record control module 126, macro playback control module 128, print menu data 130, print control module 132, and macro data 134.

Display component 122 allows print menu items and other information to be presented to a user of printing device 120 locally. Display component 122 may include, for example, one or more of a display screen (e.g., an LED or LCD display), a speaker, a tactile feedback device to present Braille, etc. Local input component 124 allows users to input information to printing device 120 locally. Local input component 124 may include, for example, one or more of a keypad having one or more buttons or keys, cursor control devices (e.g., a trackball, trackpad, directional keys, etc.), a touchscreen, etc. Components 122 and 124 may also include software, firmware, and/or hardware modules to allow management and control of the corresponding hardware components (e.g., display screen, keypad, etc.). Components 122 and 124 allow a local user of device 120 (e.g., a user standing at device 120 rather than accessing device 120 via a network) to interact with device 120.

Print control module 132 manages the printing of data by device 120 in order to generate a hard copy. Print requests can be received from a computing device 102 via a network (e.g., network 106 of FIG. 1) and/or directly from a computing device 102. Print control module 132 generates the hard copy (or copies) in response to the print requests and in accordance with the print parameters set via the print menus (including any parameters set by user-selection of print menu macros), as discussed in detail below. The print request and corresponding data are also commonly referred to as a print job.

Print menu data 130 represents the possible print parameter settings for the print menu of device 120, as well as the current print parameter settings for the print menu of device 120. The current print parameter settings for the print menu of device 120 can be default settings, settings made by a user interacting with the print menu, user selection of a macro, or combinations thereof.

The print menu for device 120 can have various different print parameters that can be set using the print menu of device 120. The specific print parameters that can be set for a particular device can vary by device (e.g., as desired by the device manufacturer). Examples of such print parameters include: a number of copies to be printed, a media source, a print quality, duplex/simplex printing, a font to use for printing, an output device, PostScript errors on/off, etc. Settings for one or more of these print parameters can be defined by creating a print menu macro, and each of these one or more print parameter settings subsequently made by selection of the macro.

The duration of a particular print parameter setting can vary, and may be, for example, either indefinite or for a single print job. For example, a parameter setting for the number of copies to be printed may have the duration of a single print job and the setting returns to a default value (e.g., a value of 1) after printing of the print job is completed, whereas the print quality parameter setting may be indefinite and maintain its setting until changed by the user. Print parameters that are indefinite in duration may lose their state (current setting) when the printing device is powered down, or alternatively their state may be maintained in a nonvolatile store (e.g., a hard drive or Flash memory) and recovered when the device is powered on again.

The duration of a particular print parameter setting can be inherent in the print parameter itself, or alternatively may be a user-selectable option. In situations where the duration of a print parameter setting is user-selectable, a flag or other indication of the user-selected duration is associated with the print parameter and maintained by the printing device. Such duration settings may lose their state (current setting) when the printing device is powered down, or alternatively their state may be maintained in a nonvolatile store and recovered when the printing device is powered on again.

Macro record control module 126 manages the recording of the print menu macros for printing device 120. When a user of printing device 120 requests to begin recording a print menu macro, macro record control module 126 is initiated. The user then inputs the command sequence he or she desires for the macro, and then requests to stop recording the print menu macro. Optionally, the user may select a name or other identifier to be associated with the macro. For example, the user can select a name that is easy for the user to remember, making it easier for the user to subsequently select from multiple macros the particular macro he or she desires.

A particular printing device 120 may support local and/or remote print menu macro recording.

The manner in which recording of a print menu macro is locally requested by the user can vary based on the manner in which local input component 124 and/or display component 122 are implemented. For example, if local input component 124 is a keypad, then recording of a macro may be requested by the user selecting a dedicated “record macro” key of the keypad, or using the keypad (or other cursor control means) to select a “record macro” print menu item from the device's print menu. By way of another example, if local input component 124 is a touchscreen overlaying (or integrated with) display component 122, then a “record macro” icon may be displayed on display component 122 and selected by the user's selecting of the appropriate part of input component 124 corresponding to the “record macro” icon.

Once recording of a macro has been initiated, the particular print parameter settings desired by the user for the macro are recorded. The manner in which the desired print parameter settings are input locally can vary based on the manner in which local input component 124 and/or display component 122 are implemented. For example, if local input component 124 is a keypad, then the desired parameter settings can be input by the user entering a sequence of one or more print menu commands using the keypad to select particular print parameters and their settings from the print menu. The user inputs are recorded by macro record control module 126 until a “stop recording” input is received by module 126. This “stop recording” input may be from a dedicated “stop recording” key of the keypad, or selection of a “stop recording” print menu item. Once the “stop recording” input is received, the macro is saved as macro data 134.

By way of another example, if local input component 124 is a touchscreen overlaying (or integrated with) display component 122, then the desired parameter settings can be input by the user entering a sequence of one or more print menu commands by selecting the appropriate parts of input component 124 corresponding to icons displayed on display component 122. The user inputs are recorded by macro record control module 126 until a “stop recording” input is received by module 126, at which point the recorded command sequence is saved as macro data 134.

By way of yet another example, rather than recording a command sequence, macro record control module 126 may simply store the current settings for the print parameters of the print menu. Thus, rather than recording the print menu command sequence as it is input by the user, the resultant state of the parameter settings of the print menu after the command sequence is input is stored.

In alternate implementations, a user can have a print menu macro recorded by interacting with printing device 120 remotely. In such implementations, macro record control module 126 includes an interface that allows a remote computing device to request recording of a macro by printing device 120 (e.g., via a network or a direct connection). This interface may allow, for example, sending of a “record macro” command to macro record control module 126. In other implementations, printing device 120 may include web server functionality that allows web pages to be communicated to the remote computing device, and a “record macro” option selected from the web page and selection of such option communicated to macro record control module 126.

When allowing a user to input the desired print parameter settings for the macro remotely, macro record control module 126 includes an interface, such as one or more web pages, that allows a user to input, at the remote computing device, the desired print menu command sequence (or the resultant state of the parameter settings of the print menu after entry of the command sequence input is completed) and transferred to printing device 120. Commands input by the user at the remote computing device may be communicated to printing device 120 as they are input by the user, or alternatively may be communicated only after entry of the sequence by the user is completed (e.g., as indicated by a “stop recording” input).

Print menu macros may also be generated on other devices and transferred to printing device 120. For example, a system administrator may generate his or her own macro(s) on a computing device using a macro generation program separate from printing device 120. Once generated, the macro(s) can be transferred to printing device 120 and be made available for subsequent user selection. Such a macro could also be transferred to multiple additional printing devices 120, thereby allowing the system administrator to generate the macro once and have it available on multiple printing devices 120.

In some implementations, macro record control module 126 may allow a previously recorded macro to be modified. Module 126 may allow a user to select a previously recorded macro and append one or more additional commands to the beginning or ending of the macro, or alternatively allow the user to scroll through the command sequence of the macro and select a location where the additional command(s) are to be added (or which command(s) are to be deleted). In implementations where module 126 records the final settings of the print parameters, rather than the command sequence used to set the parameters, module 126 may allow a user to modify any of the previous settings for the parameters. In addition, module 126 may also allow a previously recorded macro to be modified and saved as a new macro, allowing both the previously macro and the new macro to be available in printing device 120.

Once a macro has been recorded, it is saved as macro data 134. Multiple macros may be included in macro data 134, including multiple macros from the same or different users. The macros may have names or other identifiers that are assigned to them. Typically the user generating the macro assigns the name or identifier to the macro, although the name or identifier may alternatively be assigned by another person or component (e.g., by macro record control module 126).

Once a macro has been recorded and is saved in macro data 134, the macro can be selected by a user and the command sequence of the selected macro performed. A user selecting a macro for playback causes macro playback control module 128 to play back the recorded command sequence and configure print menu data 130 as if the command sequence were entered by a user through local input component 124. In situations where the macro stores the resultant state of the print parameter settings, playback control module 132 alters the appropriate parameter settings in print menu data 130 so that the settings are as indicated in the selected macro.

Printing device 120 may allow the user to select the macro locally at printing device 120 and/or from a remote computing device. The exact manner in which such selection is made can vary by implementation. For example, in situations where device 120 allows local macro selection, a dedicated key on a keypad or icon on a graphical display may be associated with the macro (and display, for example, the name of the macro as being associated with the key or icon). The user can then select the macro by selecting the key or icon. Alternatively, the print menu data 130 may include the names or identifiers of the macros on printing device 120 and the user can select the macro by navigating to the name or identifier of the macro in the print menu of device 120. By way of another example, in situations where device 120 allows remote macro selection, an icon or menu item associated with the macro (and having displayed therewith, for example, the name of the macro as being associated with the icon or menu item) may be communicated from printing device 120 to the remote computing device. The remote computing device displays, on the display device of the remote computing device (e.g., within a dialog box) the icon or menu item (and name), and the user can select the icon or menu item, in response to which the remote computing device communicates the associated macro name or identifier to printing device 120.

Thus, print menu macros allow a user(s) to define a particular combination of print parameter settings once and assign a name or other identifier to the combination. A particular print menu macro can subsequently be selected for a particular print job, resulting in the printing device generating a hard copy (copies) of the data of the print job in accordance with the print parameter settings of the selected macro.

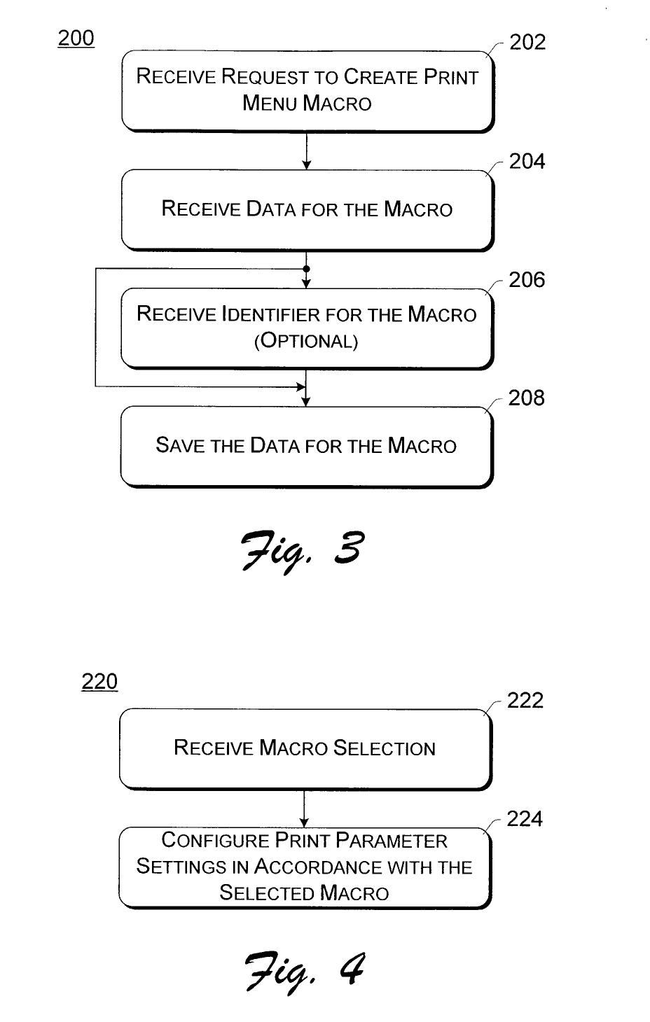

FIG. 3 is a flowchart illustrating an exemplary process 200 for creating a print menu macro. Process 200 is performed by a printing device (e.g., printing device 120 of FIG. 2), and may be performed in software, firmware, hardware, or combinations thereof.

Initially, a request to create a print menu macro is received (act 202). The data for the macro is also received (act 204). As discussed above, this data in act 204 may be a print menu command sequence or the print parameter settings resulting from a command sequence. An identifier for the macro may also optionally be received (act 206). The data for the macro is then saved (act 208).

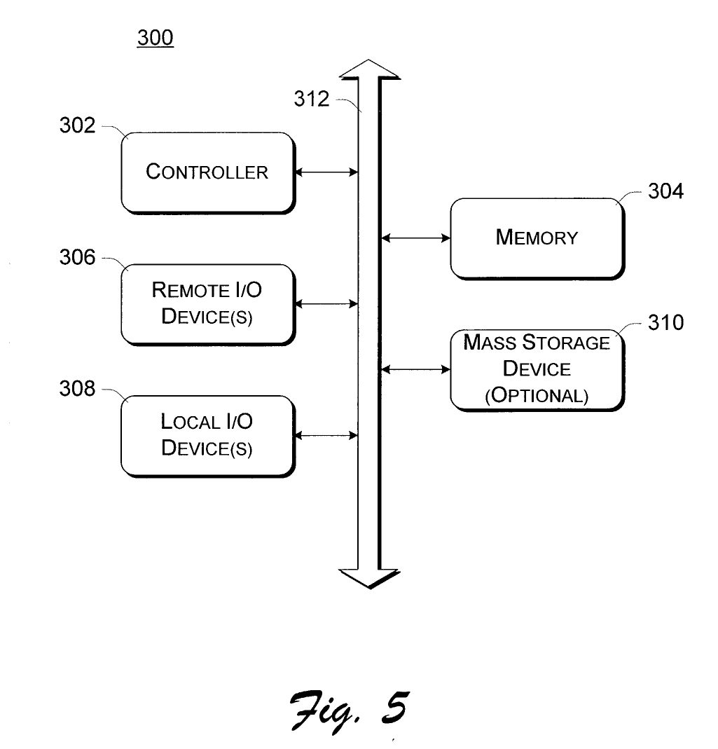

FIG. 4 is a flowchart illustrating an exemplary process 220 for playing back a print menu macro. Process 220 is performed by a printing device (e.g., printing device 120 of FIG. 2), and may be performed in software, firmware, hardware, or combinations thereof.

Initially, a selection of a macro is received (act 222). The print parameter settings of the printing device are then configured in accordance with the selected macro (act 224).

FIG. 5 illustrates portions of an exemplary device 300. Device 300 can be, for example, a computing device 102 or printing device 104 of FIG. 1, or printing device 120 of FIG. 2. Device 300 includes a processor or controller 302, a memory 304, a remote I/O device(s) 306, a local I/O device(s) 308, and an optional mass storage device 310, all coupled to a bus 312. Depending on the type of the device, various additional components may also be typically included in device 300 (e.g., a printing device will typically include a print engine, print media inputs and outputs, etc.).

Controller or processor 302 can be a general purpose microprocessor or a dedicated microcontroller (e.g., one or more Application Specific Integrated Circuits (ASICs) or programmable logic devices (PLDs)). Remote I/O device(s) 306 is one or more interface devices allowing components of device 300 (e.g., controller 302) to communicate with other devices external to device 300. Remote I/O device(s) 306 may include, for example, a modem, a network interface card (NIC), a parallel port, a serial port, a universal serial bus (USB) port, and so forth. Local I/O device(s) 308 is an interface device allowing local commands and/or data to be input to and/or output from device 300. Local I/O device(s) 308 may include, for example, a display device (e.g., liquid crystal display (LCD), light emitting diode (LED), etc.), a keypad (e.g., alphanumeric or otherwise), a touchscreen, a cursor control device (e.g., a trackpad, trackball, etc.), print media handlers and printing components (e.g., ink or toner dispensers), and so forth.

Bus 312 represents one or more buses in printing device 300, which may be implemented in accordance with public and/or proprietary protocols. The bus architecture can vary by printing device as well as by manufacturer. Mass storage device 310 is optional and represents any of a wide variety of storage devices, such as fixed or removable magnetic or optical disks, Flash memory, etc.

Memory 304 represents volatile and/or nonvolatile memory used to store instructions and data for use by controller or processor 302. Typically, instructions are stored on a mass storage device 310 (or nonvolatile memory portion of memory 304) and loaded into a volatile memory portion of memory 304 for execution by controller or processor 302. Additional memory components may also be involved, such as cache memories internal or external to controller or processor 302. Various embodiments of the invention may be implemented, at different times, in any of a variety of computer readable media that is part of, or readable by, device 300. For example, such computer readable media may be mass storage device 310, memory 304, a cache memory, media (e.g., a magnetic or optical disk) accessible to device 300, and so forth.

Device 300 is exemplary only. It is to be appreciated that additional components (not shown) can be included in device 300 and some components illustrated in device 300 need not be included. For example, additional processors or storage devices, additional I/O interfaces, and so forth may be included in device 300, or mass storage device 310 may not be included.

Various discussions herein refer to components and modules that can be implemented in a printing device or computing device. It is to be appreciated that the components and processes described herein can be implemented in software, firmware, hardware, or combinations thereof. By way of example, a programmable logic device (PLD) or application specific integrated circuit (ASIC) could be configured or designed to implement various components and/or processes discussed herein.

Additionally, the discussions above discuss print menus and print parameters. It is to be appreciated that these print menus and print parameters may include additional device-related parameters which vary based on the nature of the device. For example, a multi-function machine may include scanning or faxing capabilities, and the print menu macros may include settings related to scanning and/or faxing parameters in addition to (or in place of) printing parameters.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A printing device including an input component through which a user can input a print menu macro for the printing device.

2. A printing device as recited in claim 1, wherein the input component comprises a keypad.

3. A printing device as recited in claim 1, wherein the input component comprises a touchscreen.

4. A printing device as recited in claim 1, wherein the input component comprises a network interface to receive data defining a print menu command sequence macro from a remote computing device.

5. A printing device as recited in claim 1, wherein the input component is to record a sequence of print menu commands entered by the user.

6. A printing device including an input component through which a user can select a print menu macro for the printing device and have print parameters for the printing device set in accordance with the selected print menu macro.

7. A printing device as recited in claim 6, farther comprising a macro playback control module to play back a sequence of print menu commands of the selected print menu macro.

8. A system comprising:
a macro record control module configured to allow a user to create a print menu macro for a printing device; and
a macro playback control module configured to allow a user to select the print menu macro and have print parameters for the printing device set in accordance with the print menu macro.

9. A method implemented in a printing device, the method comprising:
receiving a request to create a print menu macro;
receiving data for the print menu macro, wherein the data identifies print menu settings for the print menu macro; and
saving, at the printing device, the data for the print menu macro.

10. A method as recited in claim 9, further comprising:
receiving a user selection of the print menu macro; and
performing a print menu command sequence of the print menu macro.

11. A method as recited in claim 9, wherein the data comprises a user-selected print menu command sequence.

12. A method as recited in claim 9, wherein the data comprises a resultant state for print parameter settings after a print menu command sequence is input.

13. A method as recited in claim 9, further comprising:
receiving a user-selected identifier for the macro;
saving the user-selected identifier; and
allowing the macro to be subsequently invoked by selection of an input associated with the user-selected identifier.

14. A method as recited in claim 9, wherein receiving the request comprises receiving the request from a local input device of the printing device, and wherein receiving the data for the print menu macro comprises receiving the data for the print menu macro from the local input device.

15. A method as recited in claim 9, wherein receiving the request comprises receiving the request from a remote computing device coupled to the printing device, and wherein receiving the data for the print menu macro comprises receiving the data for the print menu macro from the remote computing device.

16. A method as recited in claim 9, wherein the printing device comprises a printer.

17. A method as recited in claim 9, further comprising:
sending, to a remote computing device, a web page identifying a plurality of user-selectable print parameters; and
receiving, from the remote computing device, one or more user-selected print parameter settings as the data for the print menu macro.

18. A method as recited in claim 9, wherein:
receiving the request comprises receiving, as the request, a macro record command; and
receiving the data comprises receiving, as the data, a print menu command sequence input by a user using a local input component of the printing device.

19. A method as recited in claim 18, further comprising receiving, as an identification of the end of the print menu command sequence, a stop recording input from the user.

20. A method as recited in claim 9, further comprising:
receiving a request to modify the print menu macro after it is saved;
receiving modification data for the previously generated print menu macro;
modifying the data for the print menu macro based on the modification data.

21. A method as recited in claim 9, further comprising:
repeating, for each of one or more additional print menu macros, the receiving the request, receiving the data, and saving the data for the additional print menu macro.

22. A method as recited in claim 21, wherein two or more of the print menu macros are generated by two different users.

23. One or more computer readable media having stored thereon a plurality of instructions that, when executed by one or more controllers, causes the one or more controllers to:
receive a user request to create a print menu macro for a printing device;
receive data for the print menu macro, wherein the data identifies print menu settings for the print menu macro; and
save, at the printing device, the data for the print menu macro.

24. One or more computer readable media as recited in claim 23, wherein the one or more controllers are implemented in the printing device.

25. One or more computer readable media as recited in claim 23, wherein the one or more controllers are implemented in a computing device coupled to the printing device.

26. One or more computer readable media as recited in claim 23, wherein the instructions that cause the one or more controllers to save the data for the print menu macro further comprise instructions that cause the one or more controllers to save the data for the print menu macro at one or more additional printing devices.

27. A method implemented in a printing device, the method comprising:
receiving a user selection of a print menu macro; and
configuring print parameter settings for the printing device in accordance with the selected print menu macro.

28. A method as recited in claim 27, wherein the configuring comprises performing a print menu command sequence associated with the print menu macro.

29. A method as recited in claim 27, wherein receiving the user selection comprises receiving the user selection from a local input device of the printing device.

30. A method as recited in claim 27, wherein receiving the user selection comprises receiving the user selection from a remote computing device coupled to the printing device.
